(19) United States
(12) Patent Application Publication
(10) Pub. No.: US 2025/0063995 A1
(43) Pub. Date: Feb. 27, 2025

(54) HANDLING DEVICE FOR MAKING SLEEVE ASSEMBLIES WHILE MAKING USE OF AN AUTOMATED OPENING/BUFFERING/POSITIONING STATION

(71) Applicant: Joost Arie De Jong, Honselersdijk (NL)

(72) Inventor: Joost Arie De Jong, Honselersdijk (NL)

(21) Appl. No.: 18/729,556

(22) PCT Filed: Jan. 30, 2023
(86) PCT No.: PCT/EP2023/052176

§ 371 Date: Jul. 17, 2024

(30) Foreign Application Priority Data
Jan. 28, 2022 (NL) 2030767

(51) Int. Cl. A01G 13/02; B65B 9/14; B65B 41/14

(52) U.S. Cl. CPC A01G 13/0243; B65B 9/14; B65B 41/14

(57) ABSTRACT

A handling device includes an opening/buffering/positioning station that is equipped with an elongate core element for sleeve material to be pulled over an upstream end while automatically opening up the sleeve shape, and a holding construction that is configured to keep the core element in place while the sleeve material is pulled over and guided along it. An operable cutter is provided at a downstream end for each time cutting of a length of the sleeve material while leaving behind a new leading sleeve end portion at the downstream end. A gripping assembly is configured movable back and forth between the downstream end and a sleeve handling station for each time gripping the new leading sleeve end portion and then pulling the length of the sleeve material from the core element towards the sleeve handling station.

### CROSS-REFERENCE TO RELATED APPLICATIONS

This application is the National Stage of International Application No. PCT/EP2023/052176, filed Jan. 30, 2023, which claims the benefit of Netherlands Application No. 2030767, filed Jan. 28, 2022, the contents of which is incorporated by reference herein.

### FIELD OF THE INVENTION

The present invention relates to a handling device for making sleeve assemblies, in particular anti-intruder sleeve covering assemblies for potted plants, in a largely automated manner. Such sleeve covering assemblies for potted plants are destined to help to protect them against all kinds of intruders, like for example worms or larva of insects, that otherwise may lead to a disturbance and deterioration in growth of the plants, but also against weeds.

### BACKGROUND TO THE INVENTION

Such anti-intruder sleeve covering assemblies for potted plants are known from NL-2022843 in the name of the same inventor/applicant. Here it is shown and described that a plant pot with an amount of substrate material and a plant potted therein, gets provided with a flexible protective sleeve for covering the upper surface of the substrate material. For that, the sleeve comprises leading and trailing sleeve end portions that grip onto an upper circumferential edge of the plant pot, while a double-walled, and preferably also twisted, intermediate covering portion of the sleeve not only covers the upper surface of the substrate material, but also encloses leaves and/or a stem of the plant, in particular like a diaphragm. Thus intruders are prevented from trying to enter or escape from the substrate material in the plant pot, and it is no longer necessary to use environmentally unfriendly and hazardous pesticides for trying to deal with them.

In this same NL-2022843, a handling device/method is schematically shown for applying the sleeve in an automated manner. The device comprises a rotatable plant pot support for holding a plant pot. Furthermore, the device comprises a gripping assembly with opposing grippers that are operable for gripping opposing edge parts of a leading sleeve end portion. The assembly of grippers is movable up and down. In a first step, the gripping assembly can be moved from below together with the gripped leading sleeve end portion and with the intermediate sleeve covering portion trailing behind it to above a rim of the plant pot while the trailing sleeve end portion remains lying over this rim and gripping onto the plant pot. The plant pot support then may get rotated over an aimed angle of rotation around its center axis relative to the gripping assembly. This causes the intermediate sleeve covering portion to twist around the plant while narrowing its central opening until it has come to lie against the plant. In a second step, the gripping assembly then can be moved back down again, thus folding back the intermediate sleeve covering portion. In a third step, this folded-back situation, possibly combined with the intermediate sleeve covering portion enclosing itself like a diaphragm around the plant, then may get fixated by moving the gripping assembly together with the leading sleeve end portion to below the plant pot's rim. There the grippers may release it such that also this leading sleeve end portion starts to firmly grip onto the plant pot.

A disadvantage hereof is that the placing of the required lengths of sleeve material in the opposing grippers leaves to be desired. For example those lengths first need to be manually pulled of a roll and cut from it, and stored somewhere. Subsequently, at the beginning of each covering cycle of a potted plant, one of those cut off lengths of the sleeve material then needs to be grabbed and a first edge part needs to be manoeuvred between a first one of the grippers. Subsequently, a second, third and fourth edge part also need to be manoeuvred one by one between the other grippers. For that it is necessary to each time stretch the sleeve material such far that the other gripper can get reached.

This is a cumbersome and time-consuming operation, particularly when the sleeve is made out of relative vulnerable elastic mesh fabric material, like nylon, having relative small mesh openings, in particular smaller than 5 mm2. This may well lead to local damaging, like tearing, of the vulnerable sleeve material, after which it of course shall be unable to perform its aimed purpose of blocking intruders.

Furthermore, when such elastic mesh fabric material, like nylon, is used, the elasticity is prone to automatically cause the walls of the sleeve material to come to largely lie against each other, as it were closed. This makes it even more difficult to manoeuvre the respective edge parts between their grippers. The person first needs to open up the sleeve shape for being able to do this.

Even worse, this manually opening up the sleeve shape and manoeuvring the respective edge parts between the grippers while at a same time stretching the sleeve material, also brings along the risk that edge parts get gripped between the grippers that are not equally divided around the circumference of the opened up sleeve shape, and/or that edge parts get gripped that are double walled or wrinkled. Such wrong placement of edge parts between the grippers may lead to the sleeve material starting to tear and/or one or more of the edge parts snapping prematurely out of their grippers, such that the sleeve material no longer can get correctly pulled over the plant pot support and/or plant pot for making the covering assembly.

### BRIEF DESCRIPTION OF THE INVENTION

The present invention aims to overcome those disadvantages at least partly or to provide a usable alternative. In particular the present invention aims to provide a user-friendly further automated handling device with which sleeve assemblies can be made even more efficiently, cost-effective and accurately.

According to the present invention this aim is achieved by a handling device for making sleeve assemblies, in particular anti-intruder sleeve covering assemblies for potted plants. The handling device comprises:
a supply station of flexible protective sleeve material, in particular elastically stretchable flexible protective sleeve material, for example made out of a meshed nylon material, more in particular having relative small mesh openings, like smaller than 5 mm²;
a sleeve handling station; and
a gripping assembly that is configured movable back and forth relative to the sleeve handling station, and that is equipped with opposing grippers, and that is operable for:
   gripping a leading sleeve end portion of the sleeve material;
   moving this leading sleeve end portion back and forth relative to the sleeve handling station.

According to the inventive thought, the handling device further comprises:
an opening/buffering/positioning station that is provided between the supply station and the sleeve handling station, and that is equipped with:
   an elongate core element that is configured for the sleeve material coming from the supply station to be pulled over an upstream end of the core element and guided along the core element while automatically opening up the sleeve shape to outer cross-sectional dimensions of the core element; and
   a holding construction that is configured to keep the core element in place while the sleeve material is pulled over and guided along it,
an operable cutter that is provided at a downstream end of the core element and that is configured for each time cutting of a length of the sleeve material while leaving behind a new leading sleeve end portion at the downstream end of the core element,
   wherein the gripping assembly is configured movable back and forth between the downstream end of the core element and the sleeve handling station for each time gripping the new leading sleeve end portion, and then pulling said length of the sleeve material from the core element towards the sleeve handling station.

Thus advantageously for the first time it has become possible to fully automatically take out sleeve material from a large supply, for example a roll, and automatically have the sleeve-shape open up and present its also opened-up leading sleeve end portion at a position where the gripping assembly is well able to grip it. No manual guidance or action is needed for this. Owing to the provision of the opening/buffering/positioning station with its stably held core element, the sleeve material always gets uniformly opened up and as such presented at the downstream end of the core element, where each time during a covering cycle a fresh new leading sleeve end portion gets created due to the cutter cutting of a length of the sleeve material at that position. This freshly cut new leading sleeve end portion then finds itself at an exactly defined position where it is still stably kept in place on or just below the downstream end of the core element. This makes it truly easy and reliable for the grippers of the gripping assembly to start gripping the leading sleeve end portion and perform a new cycle at the location of the sleeve handling station.

This well-defined opening up, guiding and positioning of the sleeve material at the opening/buffering/positioning station, and subsequent well-defined gripping of the leading sleeve end portion at the downstream end thereof, brings along the advantage that sleeve material now can always get correctly transferred by the gripping assembly towards the sleeve handling station. This makes those sleeve assemblies more uniform, strong and better able to be correctly handled at the handling station, like for example better able to block intrusion of strange objects into an item that gets covered with such a sleeve assembly, and/or to block escape of valuable content out of such a covered item.

A manual placing of pre-cut lengths of the sleeve material in the gripping assembly is no longer necessary. A wrong placement of the sleeve material, like double-walled or wrinkled, and/or edge parts of the leading sleeve end portion accidentally getting to loosen themselves from out of their grippers during the making of the sleeve assemblies, no longer has to occur. A lot of time can now be saved, while at the same time a damaging of the sleeve material during opening up of the sleeve shape and getting gripped by the respective grippers is prevented.

Various kinds of holding constructions can be used to keep the core element in place. The difficulty with this however is that it is not possible to fixedly hold the core element at one and the same place the entire time. This is not possible because of the fact that the circumferentially closed sleeve material needs to be able to keep on passing over and along it.

It is possible to make use of a so-called ‘floating’ core element, that is to say a core element that is delimited from leaving its place in space. This can be obtained by placing the core element in some kind of suitable external limitation frame against which the core element may freely rest upon in a longitudinal and sideways direction, while the sleeve material is able to get pulled not only over the core element but also in between the core element and the limitation frame. This can also be obtained by means of equipping the core element with a number of permanent magnets such that use can be made of repulsing magnetic forces acting between those magnets of the core element and a number of opposing magnets that are positioned around the core element. By making use of such a floating core element, the sleeve material can be pulled over and from the core element in a continuous uninterrupted manner.

In particular, the core element then may comprise an opening guiding head part at an upstream end and a positioning guiding body part at a lower downstream end, wherein the head part has larger cross-sectional dimensions than the body part for forming holding surfaces there between, and wherein the limitation frame comprises friction reducing elements, like rollers, by means of which the core element is delimited in the downstream direction as well as sideways.

The downstream end of the elongate core element, here the more slender body part, then preferably may get to lies below the upstream end of the elongate core element, here the more bulky head part, such that the floating core element due to gravity has a tendency to rest upon the limitation frame.

In a preferred embodiment the opening/buffering/positioning station that is provided between the supply station and the sleeve handling station, can be positioned above the sleeve handling station. This makes it possible for the handling device to make use of gravitational forces and for the sleeve handling station to be equipped with an operable/rotatable support for holding and manoeuvring objects that are to be provided with the sleeve assemblies.

In a preferred embodiment, however, the holding construction may comprise operable upstream and downstream holders that are configured to alternatingly hold the core element in place. Thus advantageously, it has become possible to each time fixedly hold the core element in place by the two holders neatly taking over from each other while alternatingly having them switch between activated holding states and inactivated releasing states.

Thus, during a buffering phase, the downstream holder(s) can be activated for fixedly holding and thus keeping the core element in place, while the upstream holder(s) may be released and set free such that the sleeve material then can be pulled from out of the supply station over the core element. In this buffering phase at least a length of the sleeve material can get buffered over the core element in front of the downstream holder(s). Subsequently, during a feeding phase, the upstream holder(s) can be activated for fixedly holding and thus keeping the core element in place, while the downstream holder(s) may be released and set free such that the sleeve material that has been buffered on the core element then can be pulled from the core element by the gripping assembly towards the sleeve handling station.

The alternatingly operable upstream and downstream holders may comprise controllable magnets that are configured to alternatingly hold corresponding parts of the upstream and downstream ends of the core element by means of magnetic attraction. Thus advantageously a well controllable and reliable holding construction is obtained, for which it makes no difference that sleeve material finds itself in between the magnets and the core element. The sleeve material runs no risk of getting damaged by the switching magnets.

In addition thereto or in the alternative those upstream and downstream holders may be movable sideways into and out of contact with the core element. Thus advantageously an even further improved switchable fixed holding can be obtained between the activated ones of the holders and the core element, particularly if opposing ones of both the upstream and downstream holders are provided that are configured to move sideways towards each other in their activated holding positions, and to move sideways away from each other in their released non-holding positions. This brings the advantage that the sleeve material is able to pass along the released holders without touching them, and thus with less effort and no risk of getting damaged. Furthermore, this brings the advantage that the sleeve material can truly be blocked by the activated holders. This makes it possible to immediately block the sleeve material with the downstream holders, as soon as the length of sleeve material has been pulled off the core element by means of the gripper moving towards the sleeve handling station.

In a preferred further or alternative embodiment the opening/buffering/positioning station further may be equipped with:
one or more operable pushers that are positioned alongside the core element in between the upstream and downstream ends thereof, and that are configured to pull the sleeve material coming from the supply station to be pulled over the upstream end of the core element and guided along the core element while automatically opening up the sleeve shape to the outer cross-sectional dimensions of the core element.

In addition thereto those one or more operable pushers can be configured to, during the earlier mentioned buffering phase, push the sleeve material coming from the supply station forward while rolling up at least said length of the sleeve material in front of the activated downstream holder(s). Thus advantageously a new amount of the sleeve material can already be buffered onto the core element, while the gripping assembly is still busy at the sleeve handling station.

In addition, those one or more operable pushers can be movable back and forth along the core element between the upstream and downstream holders, while also being movable sideways into and out of contact with the sleeve material and/or core element. Thus advantageously the pushers, for each buffering action, can be moved towards the upstream end, there be moved sideways into contact with the sleeve material and/or core element such firmly that when then getting moved towards the downstream end, the sleeve material gets pushed along in front of the pushers, while a same amount of new sleeve material then gets simultaneously pulled out of the supply station. Subsequently, the pushers can be set free again and moved back again towards the upstream end, for a new buffering action to begin.

In a preferred further or alternative embodiment the core element at its downstream end may define recesses that are configured for the grippers to move into during gripping of the new leading sleeve end portion. Thus advantageously well-defined positions are obtained for the grippers to grip the new leading sleeve end portion without being hindered whatsoever by the core element itself.

In a preferred further or alternative embodiment, when using elastically deformable stretch sleeve material, the opposing grippers of the gripping assembly may be movable relative to each other in opposing sideways directions between inner gripping positions and outer stretching positions,
wherein the inner gripping positions correspond to the opened up sleeve shape's cross-sectional dimensions at which the new leading sleeve end portion is left behind by the cutter at the downstream end of the core element, and
wherein the outer stretching positions correspond to stretched out sleeve shape's cross-sectional dimensions that are larger than the opened up sleeve shape's cross-sectional dimensions. Thus advantageously, the buffering and positioning over and onto the core element may take place while the sleeve material is not yet or only slightly stretched, whereas the further handling at the sleeve handling station can take place while at least the gripped leading sleeve end portion in its stretched out shape may get manoeuvred unhindered over for example an item to be covered and/or a support of the sleeve handling station, with the rest of the length of sleeve material getting pulled along behind it.

In a preferred further or alternative embodiment, the sleeve handling station can be a sleeve covering station that is equipped with a support for holding an item, in particular a plant pot with a potted plant therein, wherein the gripping assembly then may be configured movable back and forth relative to the support, and wherein the opposing grippers then may be operable for gripping the leading sleeve end portion of the sleeve material, and moving this leading sleeve end portion back and forth relative to the support for making a sleeve covering assembly around the item held therein.

The invention also relates to an opening/buffering/positioning station for use in the handling device, as well as to a method for making sleeve assemblies with the handling device, as well as to the use of the handling device for making anti-intruder sleeve covering assemblies around plant pots with potted plants therein.

Further preferred embodiments of the invention described herein.

### BRIEF DESCRIPTION OF THE DRAWINGS

The invention shall now be explained in more detail below by means of describing some exemplary embodiments in a non-limiting way with reference to the accompanying drawings, in which:

FIG. 1a schematically shows a side view of the supply station, the opening/buffering/positioning station and the sleeve handling station of an embodiment of the handling device according to the invention during a covering phase at the sleeve handling station while simultaneous a buffering phase takes place at the opening/buffering/positioning station;

FIG. 1b shows the view of FIG. 1a at the start of a feeding phase after the covering and buffering phases have been completed;

FIG. 1c shows the view of FIG. 1b at the end of the feeding phase and at the start of a covering phase;

FIG. 2 shows an enlarged view of the opening/buffering/positioning station of FIG. 1, but then without the sleeve material already being pulled over it;

FIG. 3a shows the gripping assembly at a downstream end of the core element of the opening/buffering/positioning station with the grippers in inner gripping positions, but then with only a small section of the unstretched leading sleeve end portion being shown in between the grippers;

FIG. 3b shows the gripping assembly at a lower end of the support of the sleeve handling station with the grippers in outer stretching positions, with only a small section of the stretched length of sleeve material being shown in between the grippers;

FIG. 4 schematically shows an embodiment a ‘floating’ type core element;

FIGS. 5a and 5b show front and side views of an opening/buffering/positioning station with the ‘floating’ type core element;

FIGS. 6a1 and 6a2 schematically show a perspective and side view of the supply station and the opening/buffering/positioning station of FIG. 5 in combination with a sleeve handling station during a buffered starting and gripping phase;

FIGS. 6b1 and 6b2 show the views of FIGS. 6al and 6a2 at the start of a subsequent feeding phase;

FIGS. 6cl and 6c2 show the views of FIGS. 6b1 and 6b2 at the end of the feeding phase and at the start of a covering phase;

FIG. 7a-e schematically shows a method for making an anti-intruder covering assembly with a single-walled sleeve covering portion; and

FIG. 8 shows the anti-intruder covering assembly with single-walled sleeve covering portion obtained therewith.

### DETAILED DESCRIPTION OF THE INVENTION

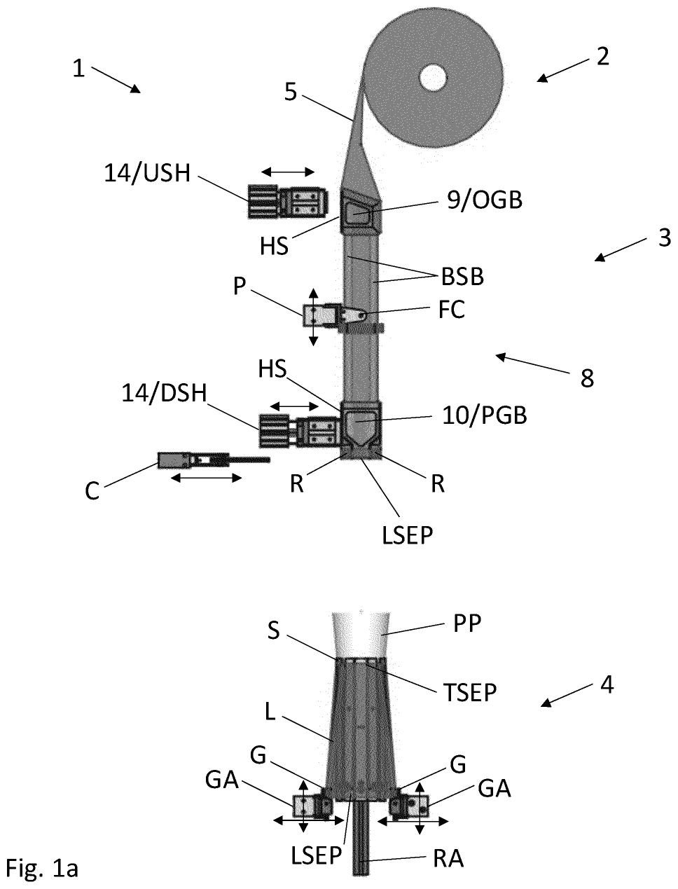

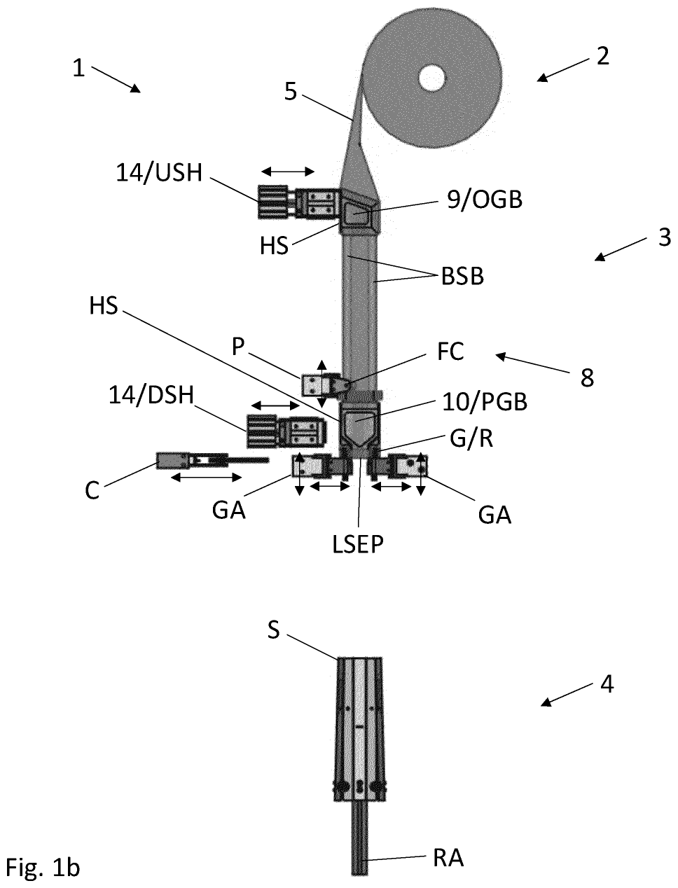

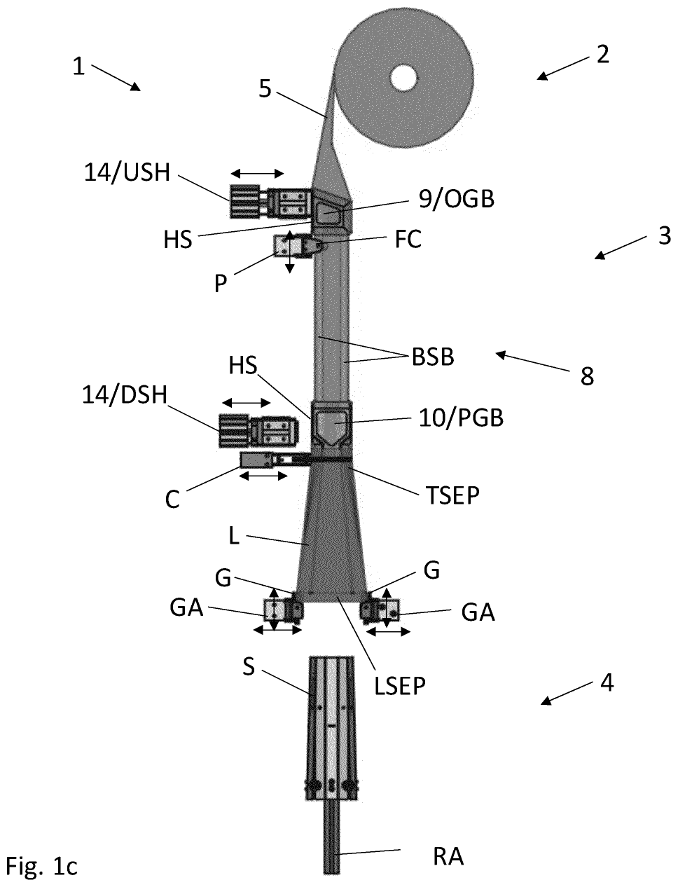

The entire handling device has been given the reference numeral 1 in FIG. 1a. The device 1 comprises a supply station 2, an opening/buffering/positioning station 3, and a sleeve handling station 4.

The supply station 2 comprises an amount of elastically stretchable flexible protective sleeve material 5, for example made out of a meshed nylon material, that here is wound in a flat state on a roll. The roll is freely rotatably supported by means of suitable roller bearing.

The opening/buffering/positioning station 3 comprises an elongate core element 8. This core element 8 here is formed by two buffering sliding bars BSB that extend in a longitudinal feeding direction between an opening guiding block OGB at an upstream end 9 and a positioning guiding block PGB at a downstream end 10 of the core element 8. The opening guiding block OGB, the buffering sliding bars BSB, and the positioning guiding block PGB comprise angled/rounded portions such that the sleeve material 5 coming from the supply station 2 can smoothly slide over and along them while automatically opening up its sleeve shape. The opening guiding block OGB and the positioning guiding block PGB both comprise flat holding side surfaces HS that are made out of metal.

At the height levels of those flat holding surfaces, a holding construction 14 with upstream and downstream holders USH, DSH are provided that are configured to alternatingly hold the core element 8 in place. For that, the holders USH, DSH here are formed by controllable electromagnets that each individually, are movable sideways into and out of contact with the core element 8 while at a same time getting energized or de-energized. Thus those respective holders USH, DSH are alternatingly operable such that the core element 8 each time when that is required is merely held hanging down from the activated upstream holder USH (FIG. 1a), or is merely held standing up from the activated downstream holder DSH (FIGS. 1b and 1c).

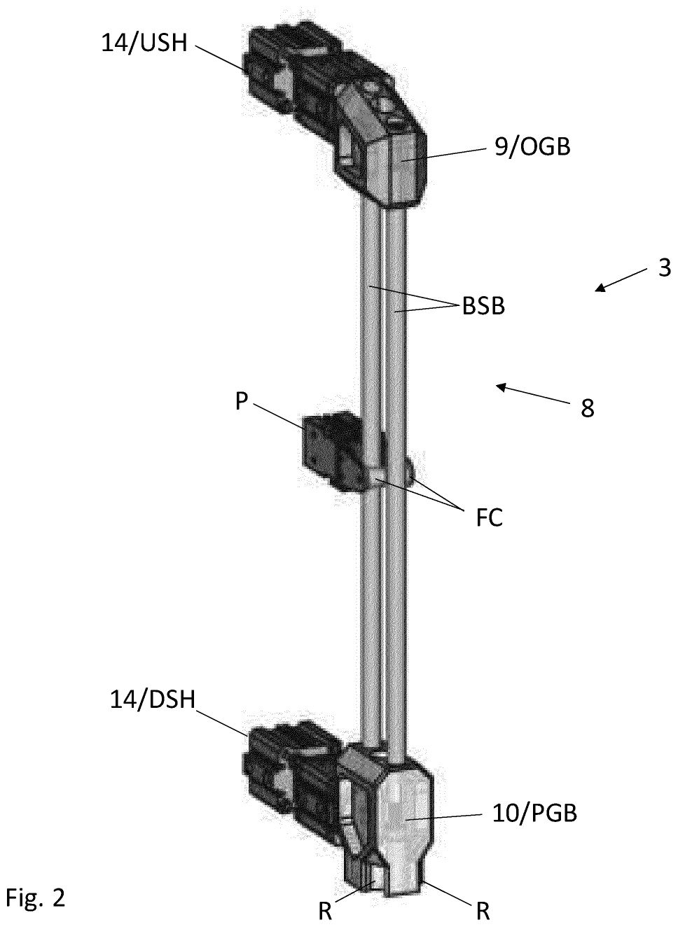

A pusher P is provided sideways of the buffering sliding bars BSB. This pusher P is movable up and down along the core element 8. Furthermore, this pusher P comprises two operable friction clamps FC that can be moved inwards into activated pushing positions and outwards towards de-activated non-pushing positions. See also FIG. 2. In the activated pushing positions, the two friction clamps FC are configured to push such strong against each other at a position in between the two buffering sliding bars BSB, that they are well able to clamp opposing wall portions of the opened up sleeve material 5 that lies there against each other. Thus a downwards pulling force can be exerted by the pusher P onto the sleeve material 5.

A cutter C is provided at a resting position underneath the downstream holder DSH. This cutter C is movable sideways towards a cutting position underneath the positioning guiding block PGB to there perform a cutting operation on the sleeve material 5. As a result of such a cutting action a leading sleeve end portion LSEP is obtained.

The sleeve handling station 4 comprises a support S for holding a plant pot PP with a potted plant (not shown) therein. For that the support S here is formed by an operable clamp that can be moved between a closed clamping and an opened non-clamping position, such that plant pots PP can easily be placed therein and removed therefrom in the opened position, and reliably be held rotation-fixed therein in the closed position. This makes it possible to have the support S together with the plant pot PP clamped therein exert a rotation relative to the rest of the handling device 1 during a covering operation. This rotation can be introduced via a rotation axis RA and suitable rotation drive mechanism RDM with which the support S is connected.

A gripping assembly GA is provided that is movable up and down between the positioning guiding block PGB and the support S. The gripping assembly GA comprises four grippers G at corner positions of opposing sub-assemblies. Those opposing grippers G are movable relative to each other in opposing sideways directions between outer stretching positions (FIGS. 1a and 1c) and inner gripping positions (FIG. 1b).

The positioning guiding block PGB at the corners of its lower side defines four recesses R that are configured for the grippers G to move into when they are in their inner gripping positions. See also FIG. 2.

In the inner gripping positions the grippers G lie at relative sideways positions of each other that correspond to the opened up sleeve shape's cross-sectional dimensions at which the new leading sleeve end portion LSEP is left behind by the cutter C at the downstream end 10 of the core element 8.

In the outer stretching positions the grippers G lie at relative sideways positions of each other that correspond to stretched out sleeve shape's cross-sectional dimensions that are larger than outer cross-sectional dimensions of the support S of the sleeve handling station 4.

The different phases to be performed by the handling device 1 during a covering action shall now be explained with reference to FIG. 1a-1c.

The buffering phase:

See FIG. 1a. In the buffering phase, the downstream holder DSH is activated for holding the core element 8 in place. As a positive side effect this also results in the sleeve material 5, that finds itself at the downstream end 10 of the core element 8, being clamped against the downstream holder DSH and thus kept firmly in place. This in turns results in the freshly cut new leading sleeve end portion LSEP being kept accurately positioned around the recesses R of the lower side of the downstream holder DSH. The upstream holder USH is de-activated and moved sideways out of the way. Subsequently, the friction clamps FC are activated and the pusher P is moved downwards. Thus, a downwards pulling force is exerted by the pusher P onto the sleeve material 5. On the one hand this causes new sleeve material 5 to be pulled from out of the supply station 2 while being forced to open up over the opening guiding block OGB. On the other hand this causes the sleeve material 5 that already lies in front of the pusher P, to be rolled up and thus buffered in front of the downstream holder DSH. As soon as the pusher P reaches its lowermost position, the friction clamps FC can be deactivated again, and the pusher P can be moved freely back up again towards its uppermost position for another pulling stroke. Thus, in one or more strokes, a suitable amount of the sleeve material 5 can be buffered on the buffering sliding bars BSB. This amount at least corresponds to one length L of the sleeve material 5 that is foreseen to be used as covering for the subsequent making of the covering assembly at the sleeve handling station 4.

The gripping phase:

See FIG. 1b. In the gripping phase, the gripping assembly GA is operated to move up towards the downstream end 10 and have its grippers G move towards their inner gripping positions. Thus, those grippers G can be moved into the recesses R and grip the new leading sleeve end portion LSEP that is already waiting there. As soon as the gripping has taken place, the upstream holder USH is activated for taking over the holding of the core element 8 in place. As a positive side effect this also results in the sleeve material 5 that finds itself at the upstream end 9 of the core element 8 being clamped against the upstream holder DSH and thus kept firmly in place. The downstream holder DSH then can be de-activated and moved sideways out of the way.

The feeding phase:

See FIG. 1c. In the feeding phase, the gripping assembly GA is moved downwards while taking along the leading sleeve end portion LSEP, and while pulling along buffered sleeve material 5 off the core element 8. As soon as a length L is pulled off, the cutter C is moved sideways towards the sleeve material 5 for cutting the length L off. Just before that is done, the downstream holder DSH can already be activated for holding the core element 8 again. During the downwards moving of the gripping assembly GA, the grippers G already get gradually moved sideways towards their outer stretching positions.

The covering phase:

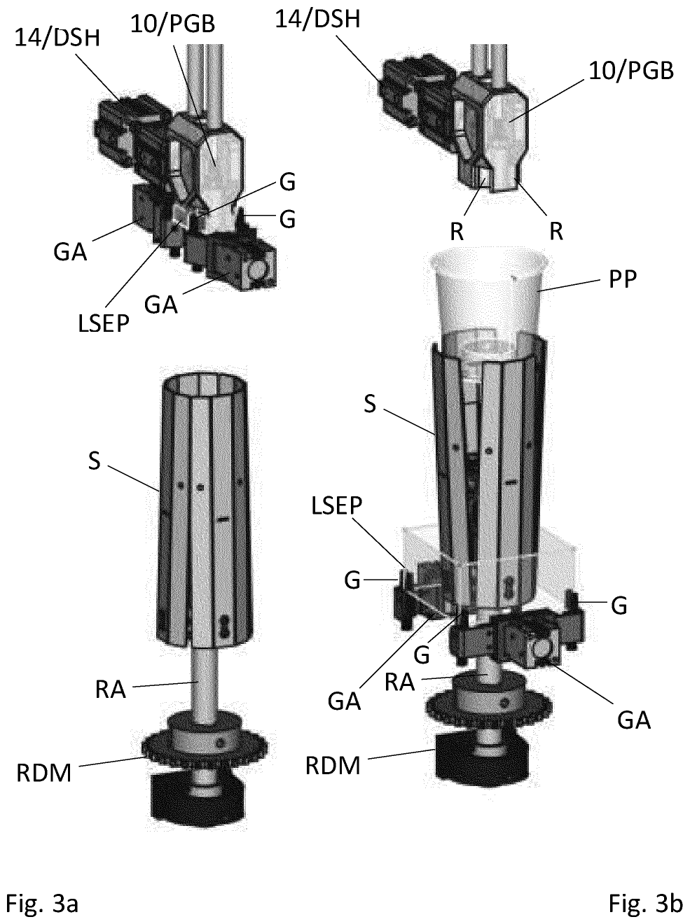

See FIG. 3. In the covering phase, the gripping assembly GA is moved further downwards while taking along the cut off length L of sleeve material 5 trailing behind it, until this entire length L has been pulled over the support S. With this, the stretched out leading sleeve end portion LSEP is able to pass the support S contactless since it has been stretched to outer cross-sectional dimensions that are larger than the ones of the support S. For the trailing length L of sleeve material 5 behind it, it goes that this shall get stretched automatically when being pulled over the support S. Subsequently, a plant pot PP can be placed in the support S, after which the gripper assembly GA can be moved back up again for pulling the length L of sleeve material 5 over the plant pot PP and thus making a covering assembly around it. This covering assembly for example can be of the type as shown and described in NL-2022843, which is incorporated by reference here, that is to say:
firstly, the gripping assembly GA is moved up such far that the gripped leading sleeve end portion LSEP gets positioned spaced above the plant pot PP, while the trailing sleeve end portion TSEP of the length L gets transferred from the support S onto a rim of the plant pot PP;
secondly, the rotation drive mechanism RDM is operated to rotate the support S, and the plant pot PP clamped therein, via the rotation axis RA for causing an intermediate covering portion of the length L of sleeve material 5 to twist around leaves and/or a stem of the plant while narrowing its central opening until it has come to lie against the plant;
thirdly, the gripping assembly GA is moved back down again such far that the gripped leading sleeve end portion LSEP gets positioned around the rim of the plant pot PP, where the grippers G are ordered to release the leading sleeve end portion LSEP such that it also shall start to firmly grip onto the rim of the plant pot PP. The intermediate covering portion then has formed an adjustable diaphragm around the plant.

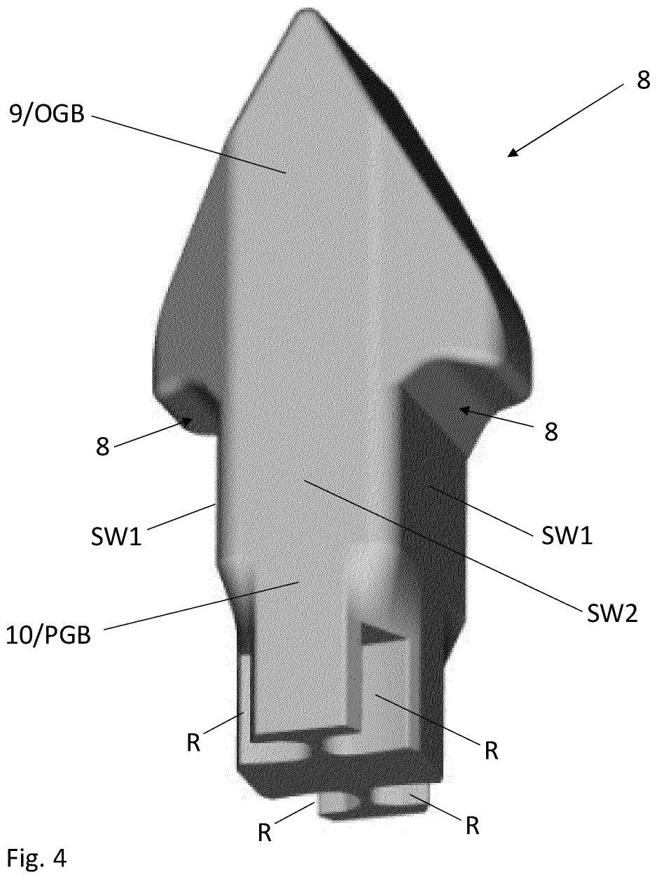

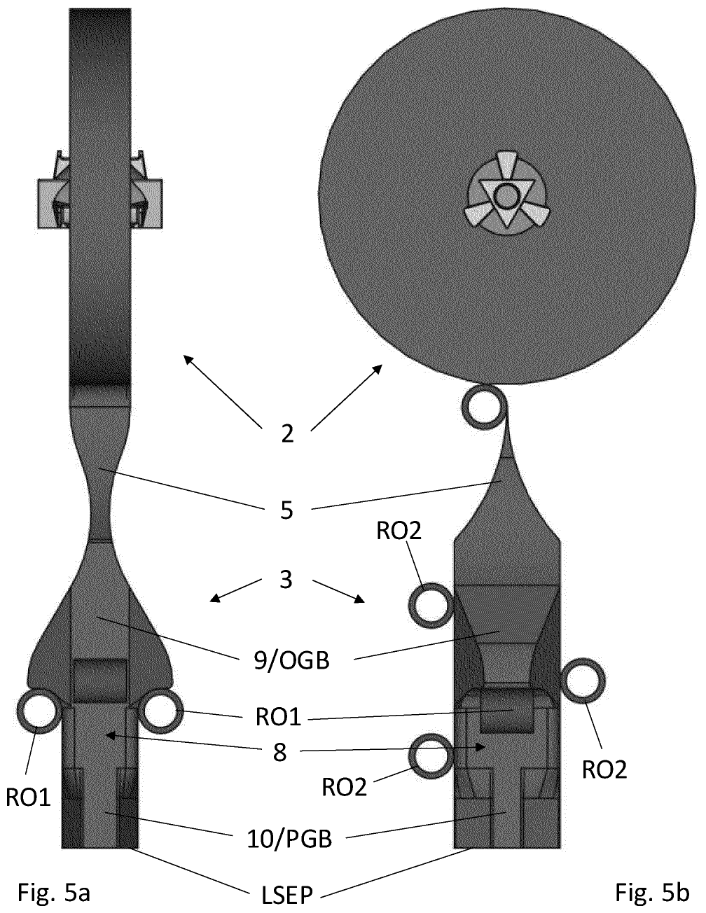

In FIG. 4-6 a variant is shown in which similar parts have been given same reference numerals.

The opening/buffering/positioning station 3 now comprises a ‘floating’ type core element 8. This core element 8 here has an elongate arrowhead shape with a central axis that extends vertically along a longitudinal downwards directed feeding direction. The core element 8 comprises an opening guiding arrow-head part OGB at an upper upstream end 9 and a positioning guiding shaft-body part PGB at a lower downstream end 10 of the core element 8. The arrow-head part OGB and the shaft-body part PGB comprise angled/rounded portions/edges/corners such that the sleeve material 5 coming from the supply station 2 can smoothly slide over and along them while automatically opening up its sleeve shape.

The arrow-head part OGB widens downwardly and at its lower end has larger cross-sectional dimensions than the shaft-body part PGB. Underneath the arrow-head part OGB two opposing holding surfaces HS are provided. The shaft-body part PGB has a square block shape. The holding surfaces HS here extend concavely shaped from underneath the arrow-head part OGB towards the side walls of the shaft-body part PGB.

At the height levels of those holding surfaces HS, a holding construction 14 is provided with a limitation frame that is configured to hold the core element 8 as it were ‘floating’ in place. The limitation frame for that comprises friction reducing elements, here formed by freely rotatable rollers RO that are fixedly held in place by the limitation frame, and by means of which the core element 8 is delimited both in the downwards direction as well as in the sideways direction. First ones of the rollers RO1 are positioned right underneath the opposing holding surfaces HS and sideways of two opposing sidewalls SW1 of the shaft-body part PGB. Second ones of the rollers RO2 are positioned sideways of remaining sidewalls SW2 of the shaft-body part PGB.

A cutter C is provided at a resting position underneath the downstream lower end of the shaft-body part PGB. This cutter C is movable sideways towards a cutting position underneath the shaft-body part PGB to there perform a cutting operation on the sleeve material 5. As a result of such a cutting action a leading sleeve end portion LSEP is obtained.

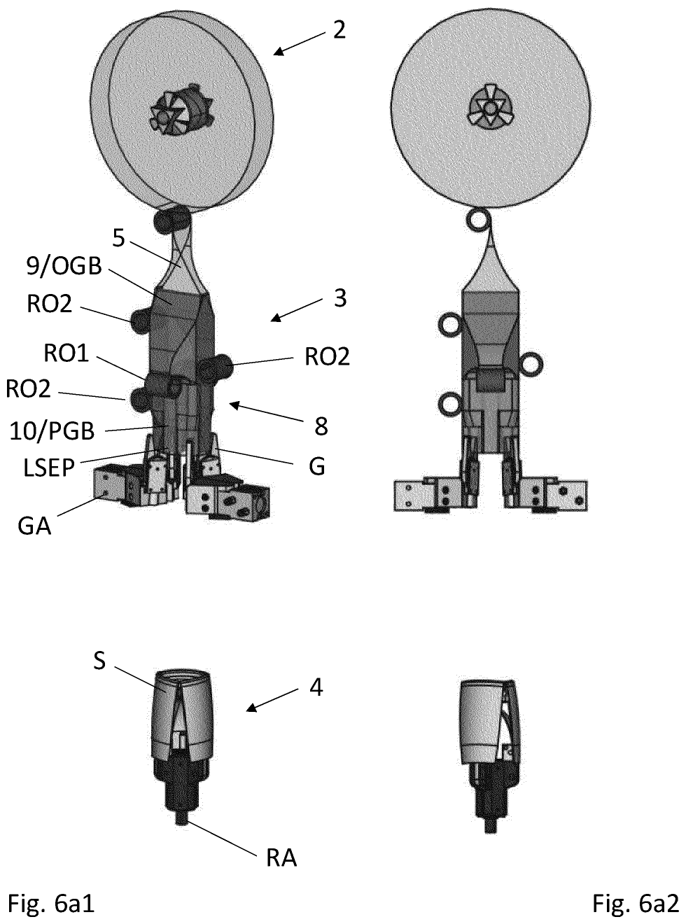

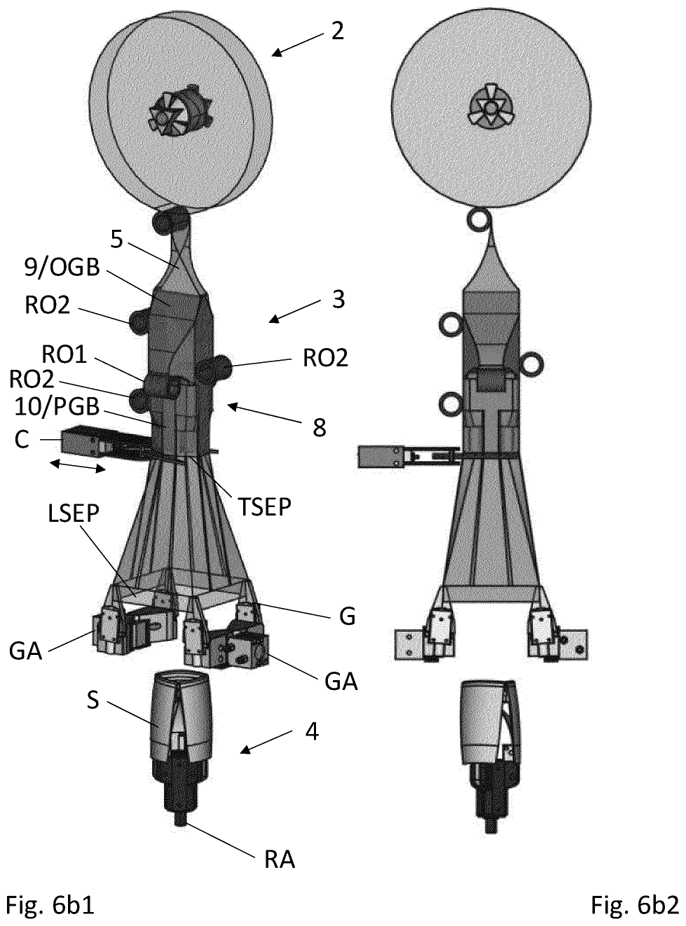

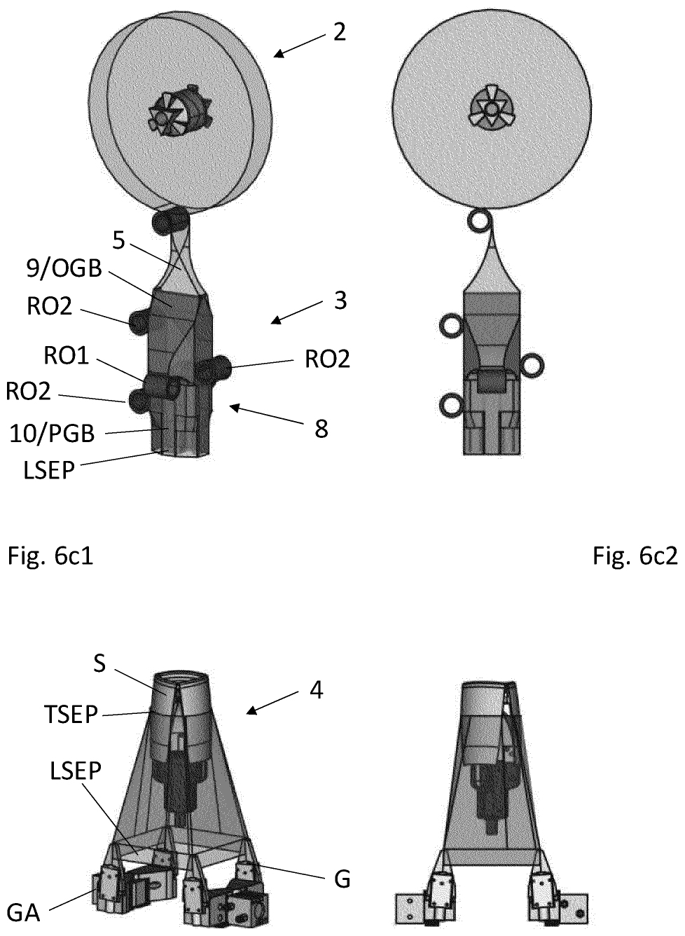

A gripping assembly GA is provided that is movable up and down between the shaft-body part PGB and the sleeve handling station 4. The gripping assembly GA comprises four grippers G at corner positions of opposing sub-assemblies. Those opposing grippers G are movable relative to each other in opposing sideways directions between inner gripping positions (FIG. 6a) and outer stretching positions (FIGS. 6b and 6c).

The shaft-body part PGB at the corners of its lower side defines four recesses R that are configured for the grippers G to move into when they are in their inner gripping positions.

In the inner gripping positions the grippers G lie at relative sideways positions of each other that correspond to the opened up sleeve shape's cross-sectional dimensions at which the new leading sleeve end portion LSEP is left behind by the cutter C at the downstream end 10 of the core element 8.

In the outer stretching positions the grippers G lie at relative sideways positions of each other that correspond to stretched out sleeve shape's cross-sectional dimensions that are larger than outer cross-sectional dimensions that are required at the sleeve handling station 4.

The different phases to be performed by the handling device 1 during a covering action shall now be explained with reference to FIG. 6a-6c.

The buffered starting and gripping phase:

See FIG. 6a. In the buffered starting and gripping phase, the core element 8 rests in place on and in between the rollers RO. Sleeve material 5 coming from the supply station 2 extends opened up over the core element 8 and in between the rollers RO. The opened up sleeve material 5 extending over the core element 8 is clamped by the weight of the core element 8 against the rollers RO and thus kept firmly in place. A freshly cut leading sleeve end portion LSEP lies accurately positioned around the recesses R of the lower side of the shaft-body part PGB. In FIG. 6a the gripping assembly GA has already been moved up towards the downstream end 10, with its grippers G in their inner gripping positions moved into the recesses R, and gripping the leading sleeve end portion LSEP.

The feeding phase:

See FIG. 6b. In the feeding phase, the gripping assembly GA is moved downwards while taking along the leading sleeve end portion LSEP, and while pulling along the opened up buffered sleeve material 5 off the core element 8. At a same time this causes new sleeve material 5 to be pulled from out of the supply station 2 while being forced to open up over the opening guiding arrow-head part OGB and buffer a new length of the sleeve material 5 over the core element 8. This new opened up buffered length exactly corresponds to one length L of the sleeve material 5 that is foreseen to be used as covering for the subsequent handling at the sleeve handling station 4. As soon as this length L is pulled off, the cutter C is moved sideways towards the sleeve material 5 for cutting the length L off. During the downwards moving of the gripping assembly GA, the grippers G may already get gradually moved sideways towards outer stretching positions.

The covering phase:

See FIG. 6c. In the covering phase, the gripping assembly GA is moved further downwards while taking along the cut off length L of sleeve material 5 trailing behind it, until this entire length L has been pulled over the support S. With this, the stretched out leading sleeve end portion LSEP is able to pass the support S contactless since it has been stretched to outer cross-sectional dimensions that are larger than the ones of the support S. For the trailing length L of sleeve material 5 behind it, it goes that this shall get stretched automatically when being pulled over the support S. Subsequently, a plant pot PP can be placed in the support S, in particular by means of an automated feeding system, after which the gripper assembly GA can be moved back up again for pulling the length L of sleeve material 5 over the plant pot PP and thus making a covering assembly around it.

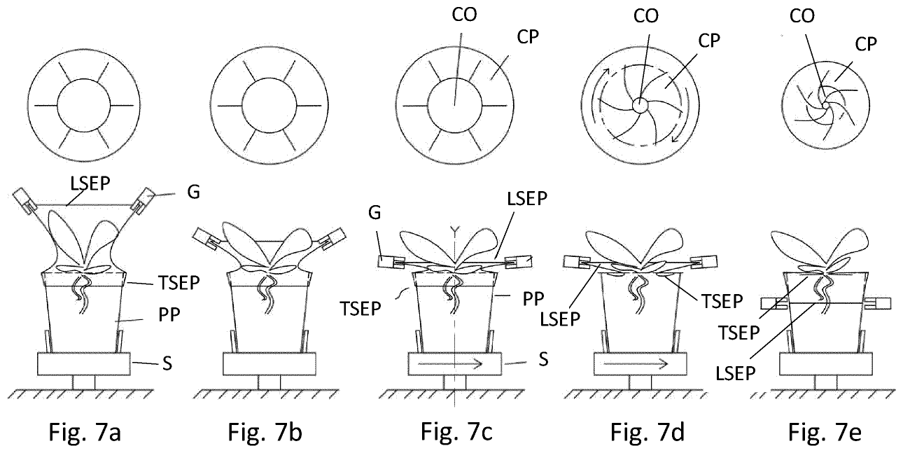

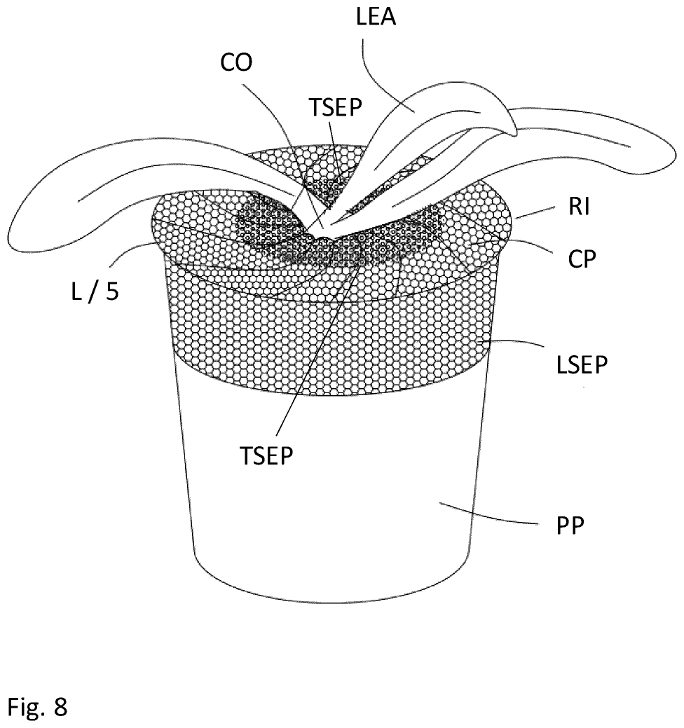

This covering assembly for example can be of the same type as shown and described for the FIG. 1-3 embodiment, but advantageously also can be as shown in FIGS. 7 and 8:
firstly, the gripping assembly GA is moved up such far that the gripped leading sleeve end portion LSEP gets positioned spaced above the plant pot PP, while the trailing sleeve end portion TSEP of the length L gets transferred from the support S onto a rim RI of the plant pot PP;
secondly, the rotation drive mechanism RDM is operated to rotate the support S, and the plant pot PP clamped therein, via the rotation axis RA for causing an intermediate covering portion of the length L of sleeve material 5 to twist around leaves LEA and/or a stem ST of the plant while narrowing its central opening CO as an adjustably closed diaphragm until it has come to lie against the plant, the rotational movement is performed such far/strong that during this rotational movement the trailing sleeve end portion TSEP of the length L of sleeve material 5 comes loose from the rim RI of the plant pot PP and shoots underneath lowermost leaves LEA of the plant;
thirdly, the gripping assembly GA is moved back down again such far that the gripped leading sleeve end portion LSEP gets positioned around the rim RI of the plant pot PP, where the grippers G are ordered to release the leading sleeve end portion LSEP such that it shall start to firmly grip onto the rim of the plant pot PP. The covering portion CP of the sleeve then extends single-walled from the gripped leading sleeve end portion LSEP towards the narrowed central opening CO that lies as the adjustably closed diaphragm around the leaves LEA and/or stem ST of the plant.

The advantage of this single-walled diaphragm closed covering of the substrate material around the leaves LEA and/or stem ST of the plant is that it helps to save sleeve material, and that it makes it easier for water and air to penetrate through its mesh structure, whereas at a same time the fact that the trailing sleeve end portion TSEP of the length L of sleeve material 5 shoots underneath lowermost leaves LEA of the plant guarantees that they get lifted up slightly and thus run less change of getting damaged by the closing diaphragm.

It is noted that this single-walled diaphragm closed covering of the substrate material around the leaves and/or stem of the plant can also be obtained in other ways and by means of other types of handling devices or even manually. This then leads to the following novel and inventive method for making an anti-intruder covering assembly, comprising the steps of:
providing a plant pot with an amount of substrate material inside the plant pot and with a plant potted in the substrate material;
providing a flexible protective sleeve, in particular elastically stretchable flexible protective sleeve material, for example made out of a meshed nylon material, more in particular having relative small mesh openings, like smaller than 5 mm²;
placing a first sleeve end portion over an upper circumferential edge of the plant pot and having it grip onto the plant pot;
twisting the plant pot and a second sleeve end portion relative to each other over an angle of rotation around a centre axis of the plant pot while narrowing a central opening that is delimited by a covering portion of the sleeve and through which leaves and/or a stem of the plant project;
folding back the second sleeve end portion while covering an upper surface of the substrate material with the covering portion of the sleeve; and
placing the second sleeve end portion over the upper circumferential edge of the plant pot and having it grip onto the plant pot,
   wherein the step of twisting the plant pot and the second sleeve end portion relative to each other over the angle of rotation around the centre axis of the plant pot while narrowing the central opening takes place preceding the step of placing the second sleeve end portion over the upper circumferential edge of the plant pot and having it grip onto the plant pot,
   wherein during the step of twisting the first sleeve end portion comes loose from the upper circumferential edge of the plant pot and shoots underneath and around the leaves and/or stem of the plant preceding the step of placing the second sleeve end portion over the upper circumferential edge of the plant pot and having it grip onto the plant pot, such that the covering portion of the sleeve gets to extend single-walled between the central opening and the second sleeve end portion.

This leads to an anti-intruder covering assembly for a potted plant, comprising:
a plant pot;
an amount of substrate material inside the plant pot; and
a plant potted in the substrate material; and
a flexible protective sleeve for covering an upper surface of the substrate material, wherein the sleeve comprises:
   a first sleeve end portion that delimits a twisted central opening through which leaves and/or a stem of the plant project
   a covering portion that covers the upper surface of the substrate material; and
   a second sleeve end portion that has been placed over an upper circumferential edge of the plant pot while gripping onto the plant pot,
wherein the covering portion of the sleeve extends single-walled between the central opening and the first sleeve end portion.

Besides the shown and described embodiments, numerous variants are possible. For example the dimensioning and shaping of the various parts can be altered. Also it is possible to make combinations between advantageous aspects of the shown embodiments. Instead of having the plant pot support made rotatable, it is also possible to have the gripper form a twister that is made rotatable around a center axis of the support.

Instead of making anti-intruder sleeve covering assemblies of a type with a folded back diaphragm covering portion, it is also possible to perform other types of handling at the handling station to the gripped and cut singulated sleeve assemblies, like make other types of coverings with the handling device. For example lengths of all other kinds of sleeve materials can also be pulled and cut in a similar automated manner from the opening/buffering/positioning station and then be pulled over a support after which they can be pulled from underneath over whatever kind of item to be covered. The used sleeve material does not even have to be elastically stretchable for that, as long as it is flexible enough to be opened up, buffered and positioned on the core element. Instead of electromagnets, all kinds of other holders can be used, like for example mechanical clamps. It is even possible to not use alternating holders at all, and instead keep the core element floating in place.

It should be understood that various changes and modifications to the presently preferred embodiments can be made without departing from the scope of the invention, and therefore will be apparent to those skilled in the art. It is therefore intended that such changes and modifications be covered by the appended claims.

1. A handling device for making sleeve assemblies, in particular anti-intruder sleeve covering assemblies for potted plants, comprising:
a supply station of flexible protective sleeve material, in particular elastically stretchable flexible protective sleeve material, for example made out of a meshed nylon material, more in particular having relative small mesh openings, like smaller than 5 mm²;
a sleeve handling station; and
a gripping assembly that is configured movable back and forth relative to the sleeve handling station, and that is equipped with opposing grippers, and that is operable for:
gripping a leading sleeve end portion of the sleeve material;
moving this leading sleeve end portion back and forth relative to the sleeve handling station,
an opening/buffering/positioning station that is provided between the supply station and the sleeve handling station, and that is equipped with:
an elongate core element that is configured for the sleeve material coming from the supply station to be pulled over an upstream end of the core element and guided along the core element while automatically opening up the sleeve shape to outer cross-sectional dimensions of the core element; and
a holding construction that is configured to keep the core element in place while the sleeve material is pulled over and guided along it, and
an operable cutter that is provided at a downstream end of the core element and that is configured for each time cutting of a length of the sleeve material while leaving behind a new leading sleeve end portion at the downstream end of the core element,
wherein the gripping assembly is configured movable back and forth between the downstream end of the core element and the sleeve handling station for each time gripping the new leading sleeve end portion, and then pulling said length of the sleeve material from the core element towards the sleeve handling station.

2. The handling device according to claim 1, wherein the holding construction comprises operable upstream and downstream holders (USH, DSH) that are configured to alternatingly hold the core element in place.

3. The handling device according to claim 2, wherein the upstream and downstream holders comprise controllable magnets that are configured to alternatingly hold corresponding parts of the upstream and downstream ends of the core element by means of magnetic attraction.

4. The handling device according to claim 2, wherein the upstream and downstream holders are movable sideways into and out of contact with the core element.

5. The handling device according claim 2, wherein the upstream and downstream holders (USH, DSH) are operable for:
during a buffering phase, activating the downstream holder(s) and releasing the upstream holder(s), such that the sleeve material is pullable from out of the supply station over the core element while said length of the sleeve material gets buffered over the core element in front of the downstream holder(s); and
during a feeding phase, activating the upstream holder(s) and releasing the downstream holder(s), such that said buffered length of the sleeve material is pullable from the core element by the gripping assembly r towards the sleeve handling station.

6. The handling device according to claim 1, wherein the opening/buffering/positioning station further is equipped with:
one or more operable pushers that are positioned alongside the core element in between the upstream and downstream ends thereof, and that are configured to pull the sleeve material coming from the supply station to be pulled over the upstream end of the core element and guided along the core element while automatically opening up the sleeve shape to the outer cross-sectional dimensions of the core element.

7. The handling device according to claim 5, wherein the one or more operable pushers are configured to, during the buffering phase, push the sleeve material coming from the supply station forward while rolling up at least said length of the sleeve material in front of the activated downstream holder(s).

8. The handling device according to claim 6, wherein the one or more operable pushers are movable back and forth along the core element between the upstream and downstream holders, and wherein the one or more operable pushers are movable sideways into and out of contact with the sleeve material and/or core element.

9. The handling device according to claim 1, wherein the holding construction comprises a limitation frame where the core element is placed in and against which the core element freely rests upon in a longitudinal and sideways direction, while the sleeve material is able to get pulled over the core element as well as in between the core element and the limitation frame.

10. The handling device according to claim 9, wherein the core element comprises an opening guiding head part at an upstream end and a positioning guiding body part at a lower downstream end, wherein the head part has larger cross-sectional dimensions than the body part for forming holding surfaces there between, wherein the limitation frame comprises friction reducing elements, like rollers, by means of which the core element is delimited in the downstream direction as well as sideways.

11. The handling device according to claim 1, wherein the core element at its downstream end defines recesses that are configured for the grippers to move into during gripping of the new leading sleeve end portion.

12. The handling device according to claim 11, wherein the core element at corners of its lower side defines at least four of the recesses, and wherein the gripping assembly comprises at least two sets of the opposing grippers at corner positions of opposing sub-assemblies.

13. The handling device according to claim 1, wherein the opposing grippers of the gripping assembly are movable relative to each other in opposing sideways directions between inner gripping positions and outer stretching positions;
wherein the inner gripping positions correspond to the opened up sleeve shape's cross-sectional dimensions at which the new leading sleeve end portion is left behind by the cutter at the downstream end of the core element, and
wherein the outer stretching positions correspond to stretched out sleeve shape's cross-sectional dimensions that are larger than the opened up sleeve shape's cross-sectional dimensions.

14. The handling device according to claim 1, wherein the sleeve handling station is a sleeve covering station that is equipped with a support for holding an item, in particular a plant pot with a potted plant therein,
wherein the gripping assembly is configured movable back and forth relative to the support, and
wherein the opposing grippers are operable for:
gripping the leading sleeve end portion of the sleeve material; and
moving this leading sleeve end portion back and forth relative to the support for making a sleeve covering assembly around the item held therein.

15. The handling device according to claim 1, wherein the opening/buffering/positioning station that is provided between the supply station and the sleeve handling station, is positioned above the sleeve handling station.

16. The handling device according to claim 1, wherein the downstream end of the elongate core element lies below the upstream end of the elongate core element.

17. An opening/buffering/positioning station for use in a handling device according to claim 1.

18. A method for making sleeve assemblies with the handling device according to claim 1, comprising the steps of:
opening/buffering/positioning sleeve material coming from the supply station by pulling it over the upstream end of the core element and guiding it along the core element while automatically opening up the sleeve shape to the outer cross-sectional dimensions of the core element;
keeping the core element in place while the sleeve material is pulled over and guided along it;
gripping a new leading sleeve end portion at the downstream end of the core element;
moving the gripped leading sleeve end portion forth towards the sleeve handling station while pulling said length of the sleeve material from the core element;
cutting of said length of the sleeve material while leaving behind a new leading sleeve end portion for a subsequent covering cycle; and
moving the gripped leading sleeve end portion back and forth relative to the sleeve handling station.

19. The method according to claim 18, wherein the step of keeping the core element in place while the sleeve material is pulled over and guided along it comprises two phases:
a buffering phase, during which the core element is fixedly held at its downstream end and set free at its upstream end such that the sleeve material is pullable from out of the supply station over the core element while said length of the sleeve material gets buffered over the core element in front of the fixedly held downstream end; and
a feeding phase, during which the core element is fixedly held at its upstream end and set free at its downstream end such that said buffered length of the sleeve material is pullable from the core element towards the sleeve handling station.

20. A method for making anti-intruder sleeve covering assemblies around plant pots with potted plants therein, comprising:
utilizing the handling device according to claim 1.
